(19) United States
(12) Patent Application Publication
(10) Pub. No.: US 2014/0175702 A1
(43) Pub. Date: Jun. 26, 2014

(54) DOUBLE-LAYER COMPOSITE METAL POWDER PARTICLE, MANUFACTURING METHOD THEREOF, AND METHOD OF MANUFACTURING SOFT MAGNETIC CORE

(71) Applicant: SAMSUNG ELECTRO-MECHANICS CO., LTD., Suwon (KR)

(72) Inventors: Hak Kwan KIM, Gyunggi-do (KR); Sung Yong AN, Gyunggi-do (KR); No Il PARK, Gyunggi-do (KR); Dong Hyeok CHOI, Gyunggi-do (KR)

(73) Assignee: SAMSUNG ELECTRO-MECHANICS CO., LTD., Suwon (KR)

(21) Appl. No.: 13/888,818

(22) Filed: May 7, 2013

(30) Foreign Application Priority Data
Dec. 21, 2012 (KR) 10-2012-0151012

(51) Int. Cl. H01F 3/08; H01F 41/02

(52) U.S. Cl. CPC H01F 3/08; H01F 41/0246
USPC 264/300; 252/62.53; 252/62.54; 427/127

(57) ABSTRACT

There is provided a method of manufacturing a double-layer composite metal powder particle, the method including preparing an iron (Fe)-based powder particle, forming an insulating layer on a surface of the iron (Fe)-based powder particle, and forming a lubricating wax coating layer on the insulating layer.

### CROSS-REFERENCE TO RELATED APPLICATIONS

This application claims the priority of Korean Patent Application No. 10-2012-0151012 filed on Dec. 21, 2012, in the Korean Intellectual Property Office, the disclosure of which is incorporated herein by reference.

### BACKGROUND OF THE INVENTION

1. Field of the Invention

The present invention relates to a double-layer composite metal powder particle, a manufacturing method thereof, and a method of manufacturing a soft magnetic core using the double-layer composite metal powder particle.

2. Description of the Related Art

In general, a soft magnetic material has been used in various applications, such as for a core in an inductor, or for a stator of an electrical apparatus such as a motor, a rotor, an actuator, a sensor or a transformer core. According to the related art, as a method of manufacturing a soft magnetic core used as a component in the electrical apparatus, a method of stacking several processed steel sheets and then integrating the stacked steel sheets has been used. However, in the case of stacking the steel sheet to manufacture the soft magnetic core, it may be difficult to manufacture a product having a complex three-dimensional shape, and a large amount of scraps may be generated.

Therefore, recently, a method of molding a soft magnetic powder particle at high pressure has been introduced. In this method, a core having a high degree of freedom in terms of shape may be manufactured. Here, the soft magnetic powder particle, a powder particle having magnetism when electricity is applied thereto, is based on iron-based soft magnetic particles. The soft magnetic core is manufactured using this soft magnetic powder particle by a general powder particle metallurgical process.

After an iron based soft magnetic material is manufactured in a powder particle form by a spraying method, a grinding method, or the like, mechanical processing, thermal treatments, and the like, are performed on the powder particle, such that the soft magnetic powder particle capable of being appropriately used as a core material may be manufactured. The soft magnetic powder particle prepared as described above is press-molded, such that the soft magnetic core having a required shape is formed.

Although soft magnetic nano-particles to which a lubricant may be added are disclosed in the following Related Art Document, in the case in which a separate lubricant is added to a powder particle, since the lubricant is not uniformly dispersed, such that a core having uniform characteristics may not be prepared.

### RELATED ART DOCUMENT

Korean Patent No. 10-0571119

### SUMMARY OF THE INVENTION

An aspect of the present invention provides a double-layer composite metal powder particle, a manufacturing method thereof, and a method of manufacturing a soft magnetic core using the double-layer composite metal powder particle.

According to an aspect of the present invention, there is provided a double-layer composite metal powder particle including: an iron (Fe)-based powder particle; an insulating layer formed on a surface of the iron (Fe)-based powder particle; and a lubricating wax coating layer formed on the insulating layer.

The lubricating wax coating layer may have a thickness of 300 to 900 nm.

Lubricating wax contained in the lubricating wax coating layer may have a melting point of 100 to 150° C.

The lubricating wax may contain at least one of ethylene bis stearamide (EBS), Zn-stearate, and polyethylene.

The insulating layer may contain ferrite.

The insulating layer may have a thickness of 50 to 1000 nm.

The iron (Fe)-based powder particle may have an average particle size of 100 to 200 μm.

The iron (Fe)-based powder particle may contain at least one alloy element of silicon (Si) and boron (B).

A content of the alloy element contained in the iron (Fe)-based powder particle may be 3.5 to 10 wt %.

According to another aspect of the present invention, there is provided a method of manufacturing a double-layer composite metal powder particle, the method including: preparing an iron (Fe)-based powder particle; forming an insulating layer on a surface of the iron (Fe)-based powder particle; and forming a lubricating wax coating layer on the insulating layer.

The lubricating wax coating layer may have a thickness of 300 to 900 nm.

Lubricating wax contained in the lubricating wax coating layer may have a melting point of 100 to 150° C.

The insulating layer may contain ferrite.

The insulating layer may have a thickness of 50 to 1000 nm.

The iron (Fe)-based powder particle may have an average particle size of 100 to 200 μm.

The iron (Fe)-based powder particle may contain at least one alloy element of silicon (Si) and boron (B).

A content of the alloy element contained in the iron (Fe)-based powder particle may be 3.5 to 10 wt %.

According to another aspect of the present invention, there is provided a method of manufacturing a soft magnetic core, the method including: preparing an iron (Fe)-based powder particle; forming an insulating layer on a surface of the iron (Fe)-based powder particle; forming a lubricating wax coating layer on the insulating layer to prepare a double-layer composite metal powder particle; preparing slurry containing the double-layer composite metal powder particle; and press-molding the slurry to manufacture a core.

The press-molding may be performed at 150 to 250° C.

The press-molding may be performed by applying 900 to 1100 MPa of pressure.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cutaway perspective view showing a double-layer composite metal powder particle according to an embodiment of the present invention;

FIG. 2 is a sequence diagram showing a manufacturing process of the double-layer composite metal powder particle;

FIG. 3 is a flow chart showing a method of manufacturing a soft magnetic core according to another embodiment of the present invention;

FIG. 4 is a sequence view showing a manufacturing process of the soft magnetic core using the double-layer composite metal powder particle; and

FIGS. 5A and 5B are scanning electron microscope (SEM) photographs showing a microstructure of the soft magnetic core.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein.

Rather, these embodiments are provided so that this disclosure will be thorough and complete, and will fully convey the scope of the invention to those skilled in the art.

Double-Layer Composite Metal Powder Particle 10

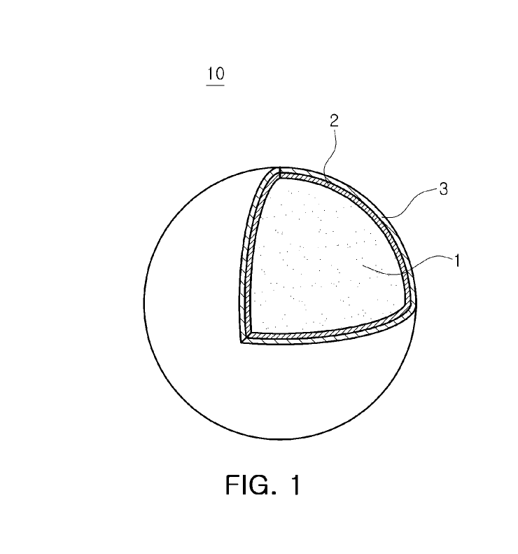

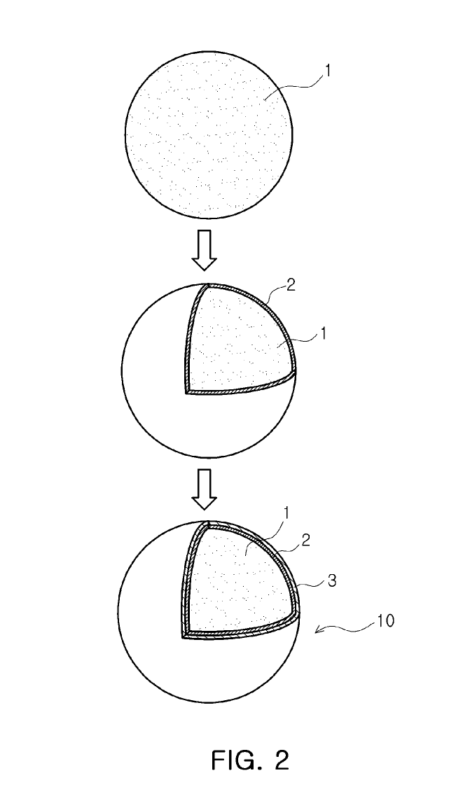

FIG. 1 is a partially cutaway perspective view illustrating a double-layer composite metal powder particle according to an embodiment of the present invention, and FIG. 2 is a sequence diagram showing a manufacturing process of the double-layer composite metal powder.

According to the embodiment of the present invention, there is provided double-layer composite metal powder particle 10 including an iron (Fe)-based powder particle 1; an insulating layer 2; and a lubricating wax coating layer 3.

In addition, according to another embodiment of the present invention, there is provided a method of manufacturing a double-layer composite metal powder particle, including: preparing an iron (Fe)-based powder particle; forming an insulating layer; and forming a lubricating wax coating layer.

Hereinafter, referring to FIGS. 1 and 2, the double-layer composite metal powder particle 10 and the manufacturing method thereof will be described in detail.

(a) Operation of Preparing Iron (Fe)-Based Powder Particle 1

The iron (Fe)-based powder particle 1, a basic material of the double-layer composite metal powder particle 10, according to the embodiment of the present invention, may be pure iron or an iron (Fe)-based alloy.

Although the term “pure iron” indicates iron that does not contain impurities and has a purity of 100% in a strict sense, since it is difficult to completely remove impurities such as carbon, nitrogen, silicon, phosphorus, sulfur, or the like, included in pig iron, generally, the term “pure iron” is used to denote iron having a relatively higher purity than other irons. In the embodiment of the present invention, the term “pure iron” is used as the general meaning as described above.

The iron (Fe)-based alloy, obtained by adding at least one alloy element that is different from iron (Fe) to iron (Fe), may have the characteristics of a metal. The alloy element is not particularly limited as long as the alloy element may increase electrical resistance and may include at least one of silicon (Si), aluminum (Al), chromium (Cr), molybdenum (Mo), and boron (B).

Silicon (Si), aluminum (Al), chromium (Cr), molybdenum (Mo), and boron (B) have an excellent effect of increasing resistance as compared with other alloy elements.

Meanwhile, a content of the alloy element contained in the iron (Fe)-based alloy may be 3.5 to 10 wt %. The higher the content of the alloy element is, the larger the electrical resistance is, such that a core loss value of a soft magnetic core 100 may be decreased. In order to allow the soft magnetic core 100 to have a core loss value of 40 W/kg or less, a general core loss value of the existing powder core, the content of the alloy element should be 3.5 wt % or more. Further, in the case in which the content of the alloy element is more than 10 wt %, the content of the alloy element increases in the manufactured soft magnetic core 100, magnetic flux density becomes 1.5T or less, a threshold value in order to be used in the motor, and the density of the soft magnetic core 100 becomes 7.6 g/cm³ or less, such that it may be difficult to apply the soft magnetic core 100 to the motor.

Therefore, the content of the alloy element contained in the alloy formed of iron (Fe)-alloy element may be 3.5 to 10 wt %.

An average particle size of the iron (Fe)-based powder particle 1 may be 100 to 200 μm. In the case in which the average particle size of the iron (Fe)-based powder particle 1 is smaller than 100 μm, the magnetic flux density of the core manufactured at the time of manufacturing the core may decrease, and in the case in which the average particle size is larger than 200 μm, the magnetic flux density may increase, but core loss may also increase, and particularly, eddy current loss causing a problem at a high frequency may be rapidly increased. Therefore, the iron (Fe)-based powder particle 1 having the average particle size of 100 to 200 μm may be prepared.

(b) Operation of Forming Insulating Layer 2

The insulating layer 2 may be formed on a surface of the iron (Fe)-based powder particle 1. The insulating layer 2 is provided to electrically isolate each of the iron (Fe) powder particles 1 to thereby decrease the eddy current loss. The insulating layer 2 may contain the ceramic or the insulating resin, but is not limited thereto.

The ceramic is not particularly limited, but may be formed of at least one selected from a group consisting of silicon dioxide, sodium silicate, and magnesium oxide. In addition, an oxide having relatively high resistance may be used.

Further, the insulating layer 2 may be formed of ferrite for excellent magnetic characteristics. In the present specification, the term “ferrite” is used as having a meaning collectively referring to a magnetic ceramic including iron oxide. Since the ferrite simultaneously has magnetism and insulation, the magnetic flux density of the core manufactured using the ferrite as the insulating layer may be further improved than that of the core manufactured using the ceramic that does not have magnetism.

In addition, the insulating resin may contain an epoxy resin, wherein the epoxy resin may be, for example, a phenol glycidyl ether type epoxy resin such as a phenol novolac type epoxy resin, a cresol novolac type epoxy resin, a naphthol modified novolac-type epoxy resin, a bisphenol A type epoxy resin, a bisphenol F-type epoxy resin, a biphenyl type epoxy resin, a triphenyl type epoxy resin, or the like; a dicyclopentadiene type epoxy resin having a dicyclopentadiene skeleton; a naphthalene type epoxy resin having a naphthalene skeleton; a dihydroxy benzopyran type epoxy resin; a glycidylamine type epoxy resin formed from polyamine such as diaminophenyl methane, or the like; a triphenolmethane type epoxy resin; a tetraphenylethane type epoxy resin; and a mixture thereof, but is not particularly limited thereto.

In addition, the insulating layer may have a thickness of 50 to 1000 nm. In the case in which the thickness of the insulating layer is thicker than 1000 nm, the magnetic flux density of the core may decrease, and in the case in which the thickness of the insulating layer is thinner than 50 nm, at the time of press-molding, a crack may be generated in the insulating layer to generate a tunneling effect, such that an insulating effect may be decreased.

(c) Operation of Forming Lubricating Wax Coating Layer 3

The lubricating wax coating layer 3 may be formed on the insulating layer 2 formed on the surface of the iron (Fe)-based powder particle 1, such that the double-layer composite metal powder particle 10 may be formed. The lubricating wax coating layer 3 is formed on each of the powder particles, such that friction force between the double-layer composite metal powder particles 10 or between the double-layer composite metal powder particle 10 and a mold wall may be significantly decreased. That is, in the case of molding the core using the double-layer composite powder particle 10 according to the embodiment of the present invention, at the time of performing a warm molding process in which the core is manufactured while the powder contact each other and are crushed by external pressure, lubricating wax may be changed into a liquid state and decrease the friction force to thereby decrease residual stress generated by press-molding and decrease hysteresis loss, such that the core having relatively low core loss may be manufactured. According to the related art, a core is molded by mixing lubricating powder on the scale of several μm with an iron (Fe)-based powder. However, when the mixing is not uniform, friction force may be increased in a portion in which the lubricating powder is lacking, such that hysteresis loss may increase. In addition, in the case in which the lubricating powder is excessively supplied, magnetic characteristics may be deteriorated due to an increase in an amount of a residual carbonaceous material after molding. Therefore, as suggested in the embodiment of the present invention, in the case in which the lubricating wax is coated on the surface of the iron (Fe)-based powder, occurrence of defects caused by non-uniform mixing of the lubricating powder particle may be prevented.

The lubricating wax coating layer 3 may be formed by dissolving the lubricating wax in a liquid state and then dipping the iron (Fe)-based powder particle 1 including the insulating layer 2 formed thereon into the dissolved lubricating wax or by applying the lubricating wax in the liquid state onto the insulating layer 2 formed on the surface of the iron (Fe)-based powder particle 1 by a spraying method and drying the applied lubricating wax, but is not limited thereto.

The lubricating wax forming the lubricating wax coating layer 3 has a melting point of 100 to 150° C. The reason is that in the case of molding the core using the double-layer composite metal powder particle 10, a molding temperature is generally 80° C. or more. In the case in which the melting point of the lubricating wax is higher than 150° C., that is, a relatively high temperature, the lubricating wax at the molding temperature is not changed into a liquid state, such that the effect of decreasing the friction force between the powder particles or between the powder and the mold may be significantly decreased.

The lubricating wax may contain at least one of ethylene bis stearamide (EBS), Zn-stearate, and polyethylene.

A melting point of ethylene bis stearamide (EBS) may be about 141 to 146° C., a melting point of Zn-stearate may be about 121 to 124° C., and a melting point of polyethylene may be about 100 to 110° C.

The lubricating wax coating layer 3 may have a thickness of 300 to 700 nm. In the case in which the thickness of the lubricating wax coating layer 3 is less than 300 nm, since the melted lubricating wax may not cover the powder enough to sufficiently decrease the friction force between the powder particles or between the powder and the mold at the time of press molding, the insulating layer may be damaged. In this case, the core loss may increase. Further, in the case in which the thickness of the lubricating wax coating layer 3 is greater than 700 nm, a content of a magnetic material in the core formed of the double-layer composite metal powder particle 10 may decrease, such that molding density and magnetic flux density may decrease, and core loss may again be increased. Therefore, the lubricating wax coating layer 3 may have a thickness of 300 to 700 nm.

Method of Manufacturing Soft Magnetic Core 100

Further, according to another embodiment of the present invention, there is provided a method of manufacturing a soft magnetic core, including preparing an iron (Fe)-based powder particle 1 (S1); forming an insulating layer 2 on the iron (Fe)-based powder (S2); forming a lubricating wax coating layer 3 on the insulating layer to prepare a double-layer composite metal powder particle 10 (S3); preparing a slurry 20 containing the double-layer composite metal powder particle (S4); and press-molding the slurry to prepare a core 100 (S5).

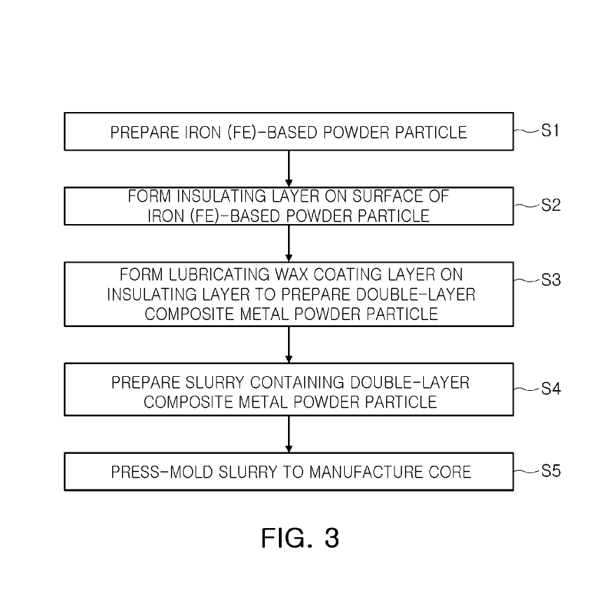

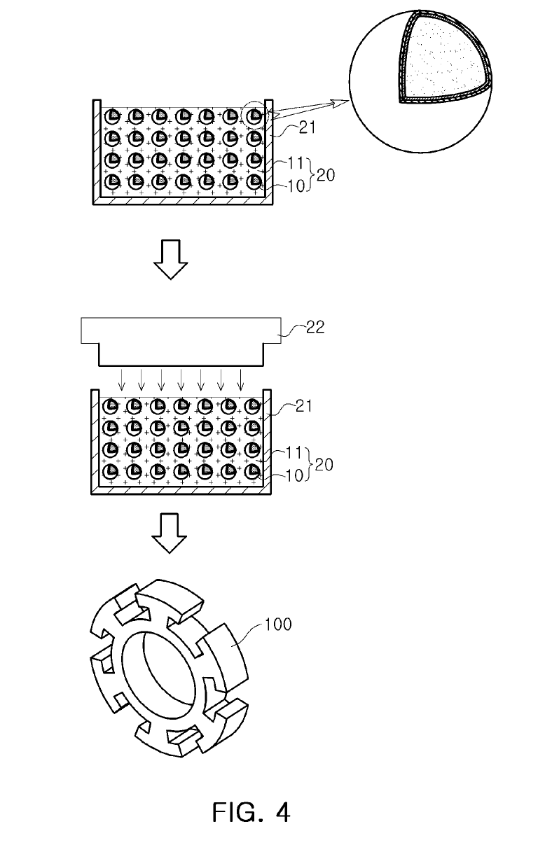

FIG. 3 is a flowchart showing a method of manufacturing a soft magnetic core 100 according to another embodiment of the present invention, and FIG. 4 is a sequence view showing a manufacturing process of the soft magnetic core 100 using the double-layer composite metal powder particle 10.

Since the preparing of an iron (Fe)-based powder, the forming of the insulating layer, and the forming of the lubricating wax coating layer to prepare a double-layer composite metal powder particle are described above, descriptions overlapped with the above-mentioned descriptions will be omitted, and the method of manufacturing a soft magnetic core will be described with reference to FIGS. 3 and 4 based on the differences.

(d) Operation of Preparing Slurry 20

The slurry 20 containing a double-layer composite metal powder particle 10 prepared according to the embodiment of the present invention as described above may be prepared. The slurry 20 may contain the double-layer composite metal powder particle 10 and an additive 11, wherein the additive may include a binder, a solvent, or the like, but is not limited thereto.

The binder may be at least one selected from a group consisting of water glass, polyimide, polyamide, silicone, a phenolic resin, and an acryl material, but is not limited thereto.

In addition, a volatile solvent may be added in order to adjust viscosity of the slurry 20. The volatile solvent may include at least one of toluene, alcohol, methyl ethyl ketone (MEK), but is not limited thereto.

(e) Operation of Manufacturing Core

This operation, which is an operation of manufacturing a soft magnetic core 100 having a required shape using the slurry 20, may be performed by a method of injecting the slurry 20 into a mold 21 having a core shape and press-molding the slurry using a press 22, but is not limited thereto.

The press-molding may be performed within a temperature range of 150 to 250° C. in which a lubricating wax coating layer 3 according to the embodiment of the present invention may be changed into a liquid state, by applying 900 to 1100 MPa of pressure, a higher degree of pressure than a general powder molding pressure according to the related art.

In the case in which the temperature at the time of press-molding is lower than 150° C., the lubricating wax coating layer 3 may not be sufficiently liquefied, such that the effect of decreasing the friction force may not be sufficiently implemented, and in the case in which the temperature is higher than 250° C., the lubricating wax coating layer changed into the liquid state may have an excessively low viscosity and start to be partially changed into a residual carbonaceous material, such that the friction force between the powder particles may increase again, and the insulating layer 2 may be easily damaged.

Describing the molding pressure, although the molding pressure increases to 900 MPa or more, a large increase in density of the manufactured core is not shown, and in the case that the molding pressure is less than 900 MPa, the density of the finally manufactured soft magnetic core may not be sufficiently secured. Further, in the case in which the molding pressure is more than 1100 MPa, a life span of the mold may be rapidly decreased.

Therefore, the molding of the soft magnetic core 100 may be performed at 150 to 250° C. and pressure of 900 to 1100 MPa.

### Experimental Example

The following Table 1 shows density, magnetic flux density, and core loss of a soft magnetic core manufactured according to a thickness of a lubricating wax coating layer of a double-layer composite metal powder particle.

The double-layer composite metal powder particle 10 used to manufacture the soft magnetic core in Experimental Examples may include an iron (Fe)-based powder particle 1 of D50=170 μm, an insulating layer 2 having a thickness of 100 nm, and a lubricating wax coating layer 3 having a thickness shown in the following Table 1.

TABLE 1

| Thickness of lubricating | Density | Magnetic flux | Core loss |
|---|---|---|---|
| wax coating layer(nm) | (g/cm³) | density (T) at 10 KA/m | (W/kg) |
| 100* | 7.67 | 1.72 | 50 |
| 200* | 7.66 | 1.71 | 49 |
| 250* | 7.66 | 1.71 | 49 |
| 300 | 7.65 | 1.70 | 42 |
| 350 | 7.65 | 1.70 | 40 |
| 400 | 7.65 | 1.69 | 40 |
| 600 | 7.64 | 1.67 | 40 |
| 650 | 7.64 | 1.66 | 40 |
| 700 | 7.63 | 1.65 | 40 |
| 750* | 7.63 | 1.64 | 42 |
| 800* | 7.62 | 1.63 | 43 |
| 900* | 7.60 | 1.60 | 43 |

*indicates a Comparative Example.

In order to allow the manufactured core to be used in a motor, the core needs to have magnetic flux density of 1.5T or more at a magnetic field intensity of 10 KA/m. To this end, the core after molding needs to have density of 7.6 g/cm³.

The characteristics of the core for a motor were satisfied in the core at all of the thicknesses at which experiments were performed.

However, as shown in Table 1, in the case in which the thickness of the lubricating wax coating layer is less than 300 nm, an insulating layer was partially damaged, such that the core loss value increased, and in the case in which the thickness of lubricating wax coating layer is more than 700 nm, the density of the manufactured soft magnetic core was low, such that the core loss value increased again.

Therefore, it could be appreciated through experimentation that the lubricating wax coating layer in order to obtain a soft magnetic core having relatively high density and magnetic flux density and relatively low core loss needs to have a thickness of 300 to 700 nm.

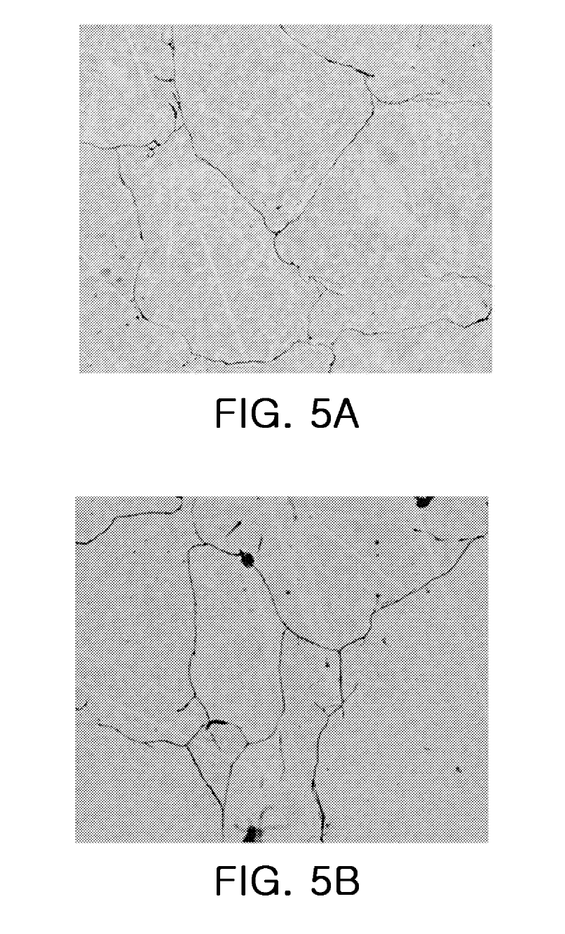

FIGS. 5A and 5B show microstructures of soft magnetic cores having different density. FIG. 5A is a microstructure of a soft magnetic core having density of 7.65 g/cm³, and FIG. 5B is a microstructure of a soft magnetic core having density of 7.5 g/cm³. As shown in FIGS. 5A and 5B, in the case of FIG. 5A, a distance between powder particles is shorter than that in the case of FIG. 5B. It could be appreciated that since the shorter the distance between the powder particles is, the better the magnetic flux density characteristics become, in the case in which the molding density is relatively high, soft magnetic core characteristics are improved.

In the double-layer composite metal powder particle 10 according to the embodiment of the present invention, the lubricating wax coating layer 3 may be additionally formed on the surface of the insulating layer 2 to obtain an effect of uniformly dispersing a lubricant at the time of molding the core, such that the core having high density and low core loss may be obtained. Further, in the case in which the insulating layer 2 is formed of ferrite, the core having the improved magnetic flux density may be obtained.

With the method of manufacturing a soft magnetic core according to the embodiment of the present invention, the soft magnetic core having density of 7.6 g/cm³ and low core loss characteristic may be obtained.

As set forth above, according to the embodiments of the present invention, a double-layer composite metal powder particle for use in manufacturing the core having high density, improved magnetic flux density and low core loss, a method of manufacturing the same, and a method of manufacturing a soft magnetic core may be provided.

While the present invention has been shown and described in connection with the embodiments, it will be apparent to those skilled in the art that modifications and variations can be made without departing from the spirit and scope of the invention as defined by the appended claims.

What is claimed is:

1. A double-layer composite metal powder particle comprising:
an iron (Fe)-based powder particle;
an insulating layer formed on a surface of the iron (Fe)-based powder particle; and
a lubricating wax coating layer formed on the insulating layer.

2. The double-layer composite metal powder particle of claim 1, wherein the lubricating wax coating layer has a thickness of 300 to 900 nm.

3. The double-layer composite metal powder particle of claim 1, wherein lubricating wax contained in the lubricating wax coating layer has a melting point of 100 to 150° C.

4. The double-layer composite metal powder particle of claim 1, wherein the lubricating wax coating layer contains at least one of ethylene bis stearamide (EBS), Zn-stearate, and polyethylene.

5. The double-layer composite metal powder particle of claim 1, wherein the insulating layer contains ferrite.

6. The double-layer composite metal powder particle of claim 1, wherein the insulating layer has a thickness of 50 to 1000 nm.

7. The double-layer composite metal powder particle of claim 1, wherein the iron (Fe)-based powder particle has an average particle size of 100 to 200 μm.

8. The double-layer composite metal powder particle of claim 1, wherein the iron (Fe)-based powder particle contains at least one alloy element of silicon (Si) and boron (B).

9. The double-layer composite metal powder particle of claim 8, wherein a content of the alloy element contained in the iron (Fe)-based powder particle is 3.5 to 10 wt %.

10. A method of manufacturing a double-layer composite metal powder particle, the method comprising:
preparing an iron (Fe)-based powder particle;
forming an insulating layer on a surface of the iron (Fe)-based powder particle; and
forming a lubricating wax coating layer on the insulating layer.

11. The method of claim 10, wherein the lubricating wax coating layer has a thickness of 300 to 900 nm.

12. The method of claim 10, wherein lubricating wax contained in the lubricating wax coating layer has a melting point of 100 to 150° C.

13. The method of claim 10, wherein the insulating layer contains ferrite.

14. The method of claim 10, wherein the insulating layer has a thickness of 50 to 1000 nm.

15. The method of claim 10, wherein the iron (Fe)-based powder particle has an average particle size of 100 to 200 μm.

16. The method of claim 10, wherein the iron (Fe)-based powder particle contains at least one alloy element of silicon (Si) and boron (B).

17. The method of claim 16, wherein a content of the alloy element contained in the iron (Fe)-based powder is 3.5 to 10 wt %.

18. A method of manufacturing a soft magnetic core, the method comprising:
preparing an iron (Fe)-based powder particle;
forming an insulating layer on a surface of the iron (Fe)-based powder particle;
forming a lubricating wax coating layer on the insulating layer to prepare a double-layer composite metal powder particle;
preparing slurry containing the double-layer composite metal powder particle; and
press-molding the slurry to manufacture a core.

19. The method of claim 18, wherein the press-molding is performed at 150 to 250° C.

20. The method of claim 19, wherein the press-molding is performed by applying 900 to 1100 MPa of pressure.
